(19) United States
(12) Patent Application Publication
(10) Pub. No.: US 2008/0261045 A1
(43) Pub. Date: Oct. 23, 2008

(54) Composite and layered particles for efficient delivery of polyelectrolytes

(76) Inventors: James R. Glass, Encinitas, CA (US); David Schultz, La Jolla, CA (US); Steven J. Oldenburg, San Diego, CA (US)

Correspondence Address: DR. DAVID SCHULTZ,;SEASHELL TECHNOLOGY LLC, No. 227, 3252 HOLIDAY COURT, LA JOLLA, CA, 92037, US

(21) Appl. No.: 12/009,467

(22) Filed: Jan. 18, 2008

Related U.S. Application Data
(60) Provisional application No. 60/886,098, filed on Jan. 22, 2007.

(51) Int. Cl. B23B 5/16; B05D 7/00

(52) U.S. Cl. 428/403; 427/213.3

(57) ABSTRACT

The invention provides a method of making composite particles for efficient delivery of polyelectrolytes to a target. Composite particles are made by two methods: 1) by first forming disperse polyelectrolyte condensates, by mixing the polyelectrolyte with a condensing agent, and then combining the disperse polyelectrolyte condensates with particles so that the disperse polyelectrolyte condensates bind to the surfaces of the particles or 2) combining particles with opposite charge polyelectrolyte to form a polyelectrolyte coated particles followed by a subsequent polyelectrolyte of opposite charge to form a composite particle. The invention includes composite particles, where each composite particle is comprised of a particle with the polyelectrolyte from one or more polyelectrolyte condensates bound to that particle. One advantage of these composite particles is that they permit more efficient and increased amounts of polyelectrolytes to be delivered to a target, in comparison to the prior art. Delivery methods include but are not limited to methods whereby the particles are accelerated to a velocity sufficient to penetrate or reach the surface of the target by pneumatic, hydraulic, transferred impulse, macro projectile, centripetal force, explosive, electric discharge, mechanical vibration, magnetic, gravimetric, or electric field.

This application claims priority from U.S. provisional application Ser. No. 60/886,098 filed 22, Jan. 2007. which application is incorporated herein by reference in its entirety.

### STATEMENT OF FEDERAL SUPPORT

This invention was made, in part, with government support under grant numbers SBIR Phase 1 1R43EB001624-01 and SBIR Phase 2 2R44EB001624-02A1 from the National Institute of Health. The United States government may have certain rights to this invention.

### FIELD OF THE INVENTION

The invention relates generally to compositions for delivering polyelectrolytes to a variety of targets, and more particularly, for delivering polynucleotides, such as DNA or RNA, to a variety of targets, including biological cells.

### BACKGROUND

Particle bombardment has been shown to be an effective method for introducing genetic material into plant and animal cells, for creating transgenic species, and for controlling and treating a variety of genetic and infectious diseases. This process is based upon coating particles with the material to be delivered, and accelerating the particles to such a momentum that they can penetrate into tissue or cells, such delivery often being referred to as “biolistic” delivery. The desired particle momentum may be achieved by high-voltage electric discharge forces, helium (or other gas) pressure, gunpowder blast, or other means. Examples of devices used for biolistic delivery are described in U.S. Pat. Nos. 4,945,050, 5,149,655, 5,179,022, 5,240,855, 5,899,880, and 6,084,154. Two commercially available gas pressure acceleration devices, the hand-held Helios™ Gene Gun and the PDS-1000/He™ are distributed by Bio-Rad Laboratories, Inc. (Hercules, Calif.).

One application of particle bombardment is the delivery of DNA into cells to achieve expression of an exogenous gene (transfection). The delivered DNA is typically in the form of a plasmid and can contain both a reporter gene and a gene that encodes for a protein of interest. The DNA is associated with a particle to form a composite particle, and the composite particle is introduced into the cells by accelerating it to sufficient velocity to penetrate the target cell. Once inside the cell the DNA can be released from the particle and then may diffuse or be actively transported to the cell nucleus where it is transcribed. The transfection efficiency is quantitatively measured by monitoring the levels of protein produced following transcription of a reporter gene. Common reporter assays include the monitoring of enzyme activity, for example beta-galactosidase, as determined by its conversion of the color of a chromogenic substrate; or luciferase that by modification of luciferin causes a change in light emission. Recently, the measurement of fluorescence from the green fluorescent protein (GFP) is increasingly used as a reporter protein. The success of the biolistic delivery process is affected by many factors including the particle size, shape and composition, the penetration depth of the particle, and the quantity and state of the material, such as DNA, delivered into the cells or tissue.

The standard protocol for the preparation of particle/DNA complexes for particle bombardment applications is essentially unchanged from its original description by Sanford et al (Sanford 1987). The current state-of-the-art describes the non-controlled aggregation and precipitation of the DNA by CaCl₂ in the presence of the particle and the free base form of a polyamine, spermidine. A number of other minor variations of the above procedures for coating particles with DNA are given in several references such as Klein et al 1988, Biotechnology, 6, 559-563; Svab et al, 1990, PNAS, 87, 8526-8530; Russell et al, 1992 In Vitro Cell Dev Biol 28, p, 97-105; Klein et al Biotechnology, 10, 286-291; and Heiser 1994, Analytical Biochemistry, 217, 185-196. O'Brien and Lummis (2000) describe improvements to sonication, washing, and processing steps that results in slightly increased transfection efficiencies. Harwood et al. (Harwood, Ross et al. 2000) have identified six different methods of coating particles for bombardment-mediated transfection of plants. Each of these methods is based upon the aggregation of DNA using CaCl₂ and the free base form of polyamine and differed in the amount of DNA and particles used in each transfection. Tuli and Sawant U.S. Pat. No. 6,406,852 have claimed improvements to the bombardment mediated delivery process both by heating the gold particles in a dry oven prior to the coating with DNA and by substitution of ethanol with isopropanol during the coating process. U.S. Pat. No. 5,879,918 describes a method for a “pre-cleaning” step that involves a strong nitric acid wash to improve the efficiency and consistency of particle bombardment applications.

The transfection efficiency achieved using particle bombardment techniques is directly related to the quantity and state of the DNA delivered to the cells, and the particle coating has been identified as one of the most important sources of variation affecting biolistic efficiency. The original inventors of the process recognized that each time DNA is precipitated, its pattern of precipitation and aggregation is unique and non-reproducible. This is verified by using a DNA binding fluorescent dye and fluorescence microscopy to assess the quantity of surface bound DNA associated with each particle. SYBR Green (Molecular Probes, Inc., Eugene, Oreg.) is an extremely sensitive DNA binding dye that emits at a wavelength of 520 nm when it binds to double-stranded DNA. The correlation of images of the gold particles, as detected with an optical microscope, with the intensity of the fluorescent signal is a metric for determining the relative quantity of DNA associated with the particles. Fluorescent analysis of particles prepared using the standard particle bombardment protocols (CaCl₂ and free base polyamine mediated aggregation) have a varying degree of DNA on the particle surface. A large percentage of the particles have no fluorescence indicating very little of the DNA has precipitated onto the particle surface. This variability in the coating of particles with DNA, when using the standard procedure, contributes to the inconsistent performance of the particle bombardment process. Leading biolistic researchers (Sanford, Smith et al. 1993) have highlighted this need for superior and more reproducible coating procedures and have identified the coating of particles as the major source of variability in the process.

In view of the above, it would be highly desirable if a composite particle population could be made for delivering greater amounts of material to a target in a functional state, particularly biolistic delivery to biological cells, but that were free of the shortcomings of current techniques.

### SUMMARY OF THE INVENTION

In view of the foregoing disadvantages inherent in the known methods and process for composite particle formulation now present in the prior art, objectives of the present invention include, but are not limited to, methods of assembling composite particles optimized for particle-bombardment-mediated delivery applications; a method and process that results in improved delivery of genetic materials, or other molecules of interest, by particle bombardment or ballistic technology; a method for producing composite particles for delivery that comprises combining genetic material, particles, and molecules that condense genetic material in a manner described below; providing a composite particle for delivering a polyelectrolyte to a target; providing, in particular, a composite particle that permits delivery of from at least two to hundred times more polyelectrolyte, such as DNA or RNA, than possible with current methods; and providing a composite particle for ballistic nucleic acid delivery applications that will overcome the shortcomings of the prior art methods.

In one aspect, the invention provides a method of preparing composite particles for delivering a polyelectrolyte to a target comprising the following steps: (i) mixing a polyelectrolyte with a condensing agent to form disperse polyelectrolyte condensates, the condensing agent being a polyelectrolyte having a charge opposite of that of the polyelectrolyte; and (ii) combining the disperse polyelectrolyte condensates with particles so that the disperse polyelectrolyte condensates bind to the surfaces of the particles to form composite particles.

In another aspect, the invention provides a method of preparing composite particles for delivering a polyelectrolyte to a target, the method comprising the steps of: (i) forming a mixture of the polyelectrolyte and a condensing agent in a low salt aqueous solution, the condensing agent being a linear polyelectrolyte having a charge opposite of that of the polyelectrolyte; and (ii) adding to the mixture particles each having a surface charge so that polyelectrolyte condensates bind to the surfaces of the particles to form composite particles.

In another aspect, the invention provides a composite particle for delivering polyelectrolyte to a target, the composite particle comprising: (i) a core particle and (ii) a coating of polyelectrolyte condensates comprising a polyelectrolyte and a condensing agent. In a preferred aspect, the composite particle of the invention comprises (i) a core particle and (ii) a coating of DNA condensates comprising DNA and a condensing agent. In one embodiment, the condensing agent is a polyamine, such as spermidine, or spermine.

In another aspect, the invention provides a multi-layered composite particle for delivering polyelectrolyte to a target, the composite particle comprising: (i) a core particle and (ii) a coating of polyelectrolyte that provides an immobilization site for polyelectrolyte or condensing agent of opposite charge. This alternating polyelectrolye interaction can be used to create multi-layered composite particles. In relation to this aspect, a multi-layered composite particle having a plurality of coatings may be produced by the following process steps: (a) providing a core particle having a charge; (b) coating the core particle or a coated particle with a first polyelectrolyte having a charge opposite to that of the core particle or the coated particle to form a partially-coated particle having a charge; (c) coating the partially-coated particle with a second polyelectrolyte having a charge opposite to that of the first polyelectrolyte to form a coated particle; and (d) repeating steps (b) and (c) until a multi-layered composite particle is formed having a plurality of coatings. This plurality of coatings is greater than 2, and is not restrictive with regard to the total number of alternating layers. In one embodiment, the initial or first polyelectrolyte layer on the core will be a positively charged entity such as polyethyleneimine, poly-lysine or poly(diallyldimethylammonium chloride) and the subsequent polyelectrolyte layer a negatively charge entity such as single or double strand DNA or RNA.

The resultant composite particles formed using the process described in this invention are more efficient in the delivery of the polyelectrolyte to a target due to increased loading of the polyelectrolyte on the particle surface. An example is shown in Table 1. A dispersed polyelectrolyte condensate was prepared by the mixing of spermidine-HCl (a condensing agent) and plasmid DNA (polyelectrolyte) in a low salt aqueous solution at pH between 3 and 11.5. Gold particles are added to the solution and polyelectrolyte condensate(s) bind to the particles. The amount of DNA bound to the particle is determined by the addition of SYBR green to the sample and the composite particles are deposited on a microscope slide and imaged using a microscope configured for epifluorescence. Quantification of SYBR green stained nucleic acid bound to the particles is determined by digital image capture and pixel intensity analysis. The amount of polyelectrolyte condensate bound to the particles using the method described in this invention is compared to the standard CaCl₂ and free base spermidine method described in the prior art and by the manufacturer and distributor of particle acceleration apparatus, Bio-Rad, Inc and used in the majority of publications describing the coating and biolistic delivery process. There is more polyelectrolyte bound per particle using the method described in this invention compared to the prior art methodology, up to or exceeding 350 times. In addition, a greater number of the particle population have visualizable polyelectrolyte bound to their surface as 98% of the composite particles prepared using this novel process are modified with polyelectrolyte (as determined by visualization of fluorescence that co-localizes with the particles), compared to only 7% of the particle population prepared by the method described in the prior art. The novel composite particles described herein also result in an increase in the efficacy of polyelectrolyte delivery (for example, DNA or RNA) using particle acceleration techniques as determined by transfection analysis (FIG. 1). Both the total number of cells transfected in a population and the expression levels in those cells is significantly increased using the composite particles described in this invention. Ballistic delivery of the novel composite particles results in greater than a 4-fold increase in the total number of green fluorescent protein (GFP) expressing Neuro2A cells in the population compared to those transfected using particles prepared by the method described in the prior art. In addition, the number of cells expressing GFP over the baseline limit of detection is substantially greater using the method described in this invention. For example, there are 12.3 times more cells expressing GFP at 10-fold over the baseline limit of expression detection using the method described in this invention as compared to the standard method. For each transfection the particles were formulated with the same quantity of DNA and total number of particles, respectively, and were delivered by the same ballistic method to each cell population. The novel composite particles described herein result in an increased expression level per cell relative to the particles prepared using the prior art method. This increase in total expression level in a target population can be as large as a 4-fold increase or greater.

The composite particles described in this invention can also be used to deliver polyelectrolytes that can function as inhibitors of gene expression. Particles comprised of a polyelectrolyte layer that has a net charge at a defined pH can be used to directly immobilize a polyelectrolyte of an opposite charge. Following the charge-charge mediated immobilization the polyelectrolytes can be directly delivered into the target. Once delivered into the target the polyelectrolyte layers will diffuse from the carrier particle surface, interact with complementary sequence which results in down-regulation of the gene of interest. An example of this approach is shown in FIG. 2. C166 mouse epithelial cells that constitutively express the reporter protein, GFP have been bombarded with composite particles containing either a 21 base pair siRNA sequence complementary to the GFP m RNA, or a non-specific RNA sequence. Following bombardment the levels of GFP expression are determined in the target cells and expression levels quantified by digital image analysis. The data in FIG. 2 show that treatment of C166 cells expressing GFP with particles coated with non-specific siRNA has no effect on GFP expression levels. However, when bombarded with composite particles created using a siRNA directed to the GFP sequence there is specific and rapid diminishment of GFP expression levels. After 24 hrs there is greater than 95% inhibition of GFP expression in cells treated with composite particles. Over time the GFP expression levels are restored with greater than 80% recovery of expression in the treated cell population. These data are equivalent to that observed for siRNA delivered to cells using other delivery technology (Elbashir et al 2002, Methods, 26, 199-213) and demonstrate that the inhibition of gene expression is sequence dependent and not a result of cellular toxicity. Non-polyelectrolyte modified gold carrier particles used in standard methods do not substantially interact with negatively charged polyelectrolytes like DNA or RNA and therefore particles used in the prior art methods do not function effectively to deliver inhibitory polyelectrolytes. The present invention is directed towards developing improved composite particles and processes for use in particle bombardment systems that deliver molecules of interest to a target, such as the interiors of living cells and tissues (ballistic delivery).

### DESCRIPTIONS OF THE DRAWINGS

FIGS. 1A-1C show data from transfection of Neuro2A cells following particle bombardment. Cells were transfected using particle prepared as described in this invention or using the current methods. Transfection analysis in Neuro2A cells following particle bombardment. Monolayer cultures of Neuro2A cells were bombarded with gold carrier particles coated using either the method described in this invention (Process II) (Panel A)(FIG. 1A) or the standard method (Process I, “Prior Art”) (Panel B)(FIG. 1B). Four hours following particle delivery GFP expressing cells were determined using fluorescence microscopy. Digital images were processed to quantify the total number of expressing cells and the maximum fluorescence in each cell. Data plotted to show the fold increase over baseline detection (Panel C)(FIG. 1C).

FIGS. 2A-2C show data demonstrating the delivery of siRNA into C166 mouse epithelial cells using composite particles. Polyelectrolyte modified gold carrier particles containing either (A) siRNA non-complementary to GFP coding sequence, acting as a negative control, or (B) siRNA complementary to GFP coding sequence were introduced into C166 cells constitutively expressing GFP using a ballistic device. The GFP fluorescence of the samples, at specified times after bombardment, was determined from digital images. Panels A and B (FIGS. 2A and 2B) are digital images that show the GFP expression level of monolayer cultures 24 hours following bombardment. A quantitative analysis of percent of “negative” control expression for cells at specified times following treatment with siRNA complementary to GFP coding sequence is shown in Panel C (FIG. 2C).

### DEFINITIONS

“Bind to” refers to the binding of the polyelectrolyte condensates to the surfaces of the particles via a hydrophobic, ionic, Van Der Waals, or covalent interaction, where bind to means that a significant portion of the polyelectrolyte and polyelectrolyte condensate remains attached to the particle such that there is improved delivery of polyelectrolye and polyelectrolyte condensate to the target.

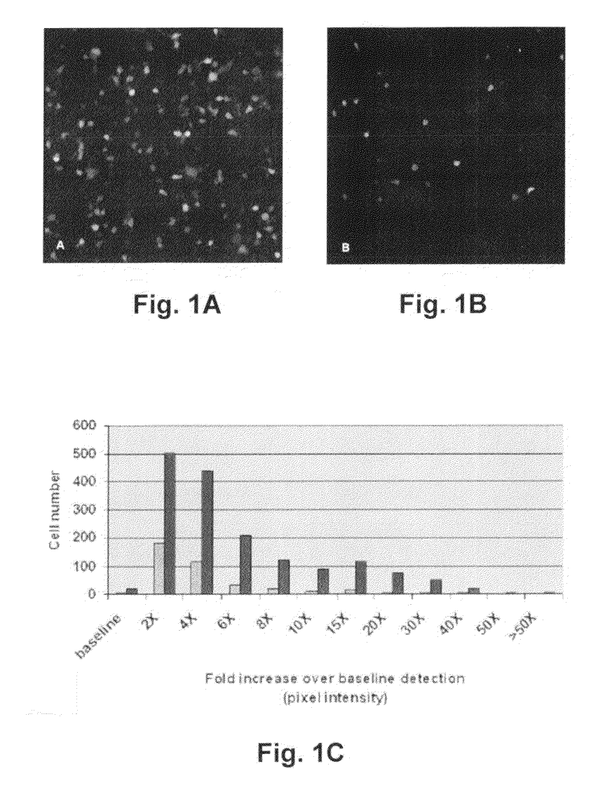

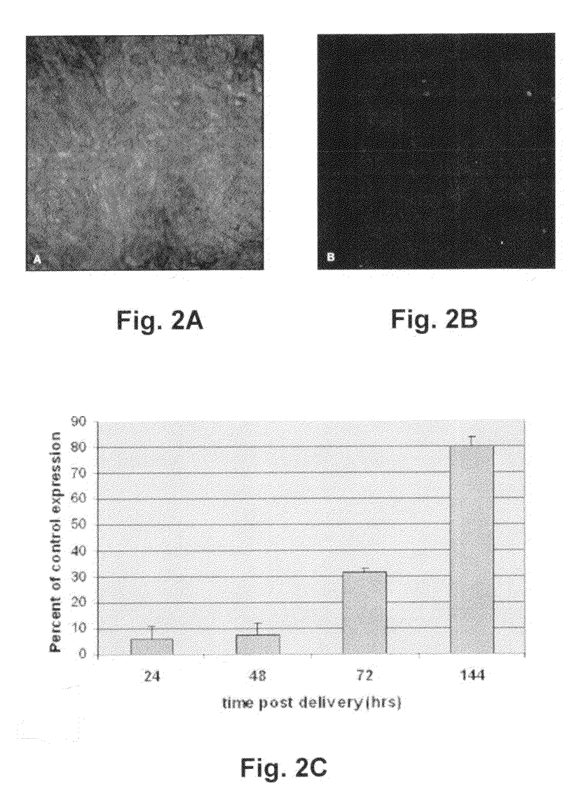

“Composite particle” is a particle that has a core, of sufficient density to penetrate a target, and a material to be delivered, usually a polyelectrolyte, on its surface. In one aspect, the materials to be delivered form disperse polyelectrolyte condensates prior to binding to a particle surface. In one aspect, composite particles preferably have one or more of the following properties: (i) High efficiency of binding material for delivery so that it remains associated with the composite particle during the delivery process, e.g. acceleration and penetration of a cell wall; (ii) Rapid and complete release of the material carried by the composite particle after delivery to a target; (iii) Material delivered retains its functional properties after release (e.g. enter the nucleus, generate a protein, or stay diffusing and serve as a monitor of its own motion, or fluoresces when attaches to something, or senses a molecule being made etc., functions to inhibit gene expression); (iv) that transforms cells with high efficiency (see FIG. 1); (v) binds a larger quantity of DNA or RNA (see Table 1); (vi) transforms a large percentage of target cells (see FIG. 1); (vii) leading to higher expression levels per unit cell (see FIG. 1); (viii) results in down-regulation of protein and gene expression (see FIG. 2) (ix) increases the polyelectrolyte stability during storage and the delivery process; (x) has a high surface area to volume ratio resulting in high loading capacity; (xi) can be delivered by pneumatic, hydraulic, transferred impulse, macro projectile, centripetal force, explosive, electric discharge, mechanical vibration, magnetic, gravimetric, electric field particle acceleration technology.

“Condensing agent” is a polyionic species that charge shields charges of the polyelectrolyte, inducing conformational change of the polyelectrolyte to yield a supermolecular structure of finite size and defined morphology. Condensing reagents include but are not limited to naturally occurring polyamines, spermidine, spermine, basic histones, high mobility group polypeptides, transition protein TP2, non-naturally occurring spermidine and spermine derivatives, cobalt hexamine, poly(ethylenimine), poly-L-lysine, and poly-L-ornithine. (Bloomfield, Va., 1996, Curr Opin Struc Biol, 6, 334-341).

“Delivery” in reference to composite particles means spatial translation, or movement, of such particles by acceleration to a velocity sufficient to penetrate or reach the surface of a target.

In one aspect, acceleration is between 100 and 5000 ft per second, and may be effected by pneumatic, hydraulic, transferred impulse, macro projectile, centripetal force, explosive, electric discharge, mechanical vibration, magnetic, gravimetric, electric field.

“Disperse polyelectrolyte condensate” is a supermolecular structure of finite size and defined morphology. Morphology of dispersed polyelectrolyte condensates may include but is not limited to toroidal, rod-like, sheet-like, fibrous, spherical, or ellipsoidal. The minor dimension of disperse polyelectrolyte condensates may be between 1 nm and 100 micron in diameter, and preferably are between 100 nm and 2 microns in diameter. Disperse polyelectrolyte condensates are “disperse” in the sense that they are non-aggregating in solutions in which they are formed and in which they are bound to particles.

“Low salt aqueous solution” refers to a solution of low enough salt so that the charges on the polyelectrolyte are not masked so as to inhibit condensate formation and polyelectrolyte interactions.

“Polynucleotides” is a genetic material or a nucleic acid such as DNA, RNA, non-natural nucleotides (PNA) including but not limited to antisense nucleic acids, siRNA, or oligonucleotides. The term polynucleotide means a polymeric unit consisting of nucleobases which are nitrogen-containing heterocyclic moieties capable of forming Watson-Crick type hydrogen bonds with a complementary nucleobase or nucleobase analog, e.g. a purine, a 7-deazapurine, or a pyrimidine. Typical nucleobases are the naturally occurring nucleobases adenine, guanine, cytosine, uracil, thymine, and analogs of naturally occurring nucleobases, e.g. 7-deazaadenine, 7-deaza azaadenine, 7-deazaguanine, 7-deaza azaguanine, inosine, nebularine, nitropyrrole, nitroindole, 2-amino-purine, 2,6-diaminopurine, hypoxanthine, pseudouridine, pseudocytidine, pseudoisocytidine, 5-propynylcytidine, isocytidine, isoguanine, 2-thiopyrimidine, 6-thioguanine, 4-thiothymine, 4-thiouracil, 06-methylguanine, N6-methyl-adenine, O4-methylthyrnine, 5,6-dihydrothymine, 5,6-dibydrouracil, 4-methylindole, and ethenoadenine, e.g. Fasman, Practical Handbook of Biochemistry and Molecular Biology, pp. 385-394, CRC Press, Boca Raton, Fla. (1989). Polynucleotides may include DNA that is single stranded, double stranded, triplet stranded linear, circular, supercoiled, multi-stranded, or synthetic. Polynucleotides may further include DNA that is a plasmid from a bacterial source. The polynucleotide may be naturally occurring or synthetic.

“Polyelectrolyte” is a macromolecular substance which, on dissolving in water or another ionizing solvent, dissociates to give polyions (polycations or polyanions)—multiply charged ions—together with an equivalent amount of ions of small charge and opposite sign. Polyelectrolytes that dissociate into polycations and polyanions, with no ions of small charge, are also included. A polyelectrolyte can be a polyacid, a polybase, a polysalt or a polyampholyte. Taken from International Union of Pure and Applied Chemistry, Manual of Symbols and Terminology for Physicochemical Quantities and Units, Appendix II, Manual on Definitions, Terminology and Symbols in Colloid and Surface Chemistry, prepared by D. M. Everett, (1971). Polyelectrolytes include but not limited to branched, linear, or circular polynucleotides, polyamino acids, dendrimers, and polypeptides.

“Target” is the interior of biological cells including but not limited to protozoans, mammalian (human, mouse, rat, hamster, rabbit, guinea pig, porcine, equine, bovine, sheep) algae, yeast, bacteria, embryonic, vertebrates, invertebrates, prokaryotes, fungi, molds, and plants, biological tissues including but not limited to brain, dermis, heart, lung, hematopoietic, liver, kidney, connective, muscle, spleen, pancreas, gonads, germ cells, stem cells, eye, epithelial, endothelial, and mesodermal, solids including but not limited to paper, plastic, agarose, membranes, polymer composites, teflon, polystyrene, acrylamide, glass, nitrocellulose, polyvinylalcohol, silicone, metals and dielectrics, liquids including but not limited to water, ethanol, tissue culture medium, broth solutions, blood, lymph fluids, mucous fluids, oils, hydrophobic and hydrophilic fluids and gases including but not limited to lung gases, atmospheric gases, oxygen, hydrogen, helium and nitrogen. The delivery into a gas is important for the cases of inhalation therapeutic delivery or dispersion of an air-borne sensor.

### DETAILED DESCRIPTION OF THE INVENTION

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting. Composite particles formed using the process described in this invention are more efficient in the delivery of the polyelectrolyte to a target due, in part, to increased loading of the polyelectrolyte on the particle surface. An example is shown in Table 1. A dispersed polyelectrolyte condensate was prepared by the mixing of spermidine (a condensing agent) and plasmid DNA (polyelectrolyte) in a low salt aqueous solution with pH between 3 and 11.5. Particles are added to the solution and polyelectrolyte condensate(s) bind to the particles. Naturally occurring polyamines are known to condense DNA into dispersed polyelectrolyte condensates of a well characterized size (Vijayanathan, Thomas et al. 2001; Trubetskoy, Wolff et al. 2003). The size of the dispersed DNA condensate depends on the concentration and the chemical structure of the polyamine. Non-limiting examples of polyamines that condense DNA are spermidine, spermine, and histones. Depending on the length, structure (linear, closed circular) and concentration of the DNA, and the concentration of polyamine, dispersed DNA condensates can be formed that have diameters of up to ˜1.5 micron (Trubetskoy, Wolff et al. 2003). In contrast to the method described in this invention the standard method, consisting of solutions containing CaCl₂ and free base spermidine (pH 11) results in the formation of amorphous aggregates of DNA. The amount of DNA associated with the particle is determined by the addition of SYBR green to the sample and the composite particles are deposited on a microscope slide and imaged using a microscope configured for epifluorescence. Quantification of SYBR green stained nucleic acid bound to the particles is determined by digital image capture and pixel intensity analysis. The amount of polyelectrolyte condensate bound to the particles using the method described in this invention is compared to the method described in the prior art (i.e. a Process I method) recommended by the manufacturer and distributor of particle acceleration apparatus, Bio-Rad, Inc and described extensively in the literature. There is more polyelectrolyte bound per particle using the method described in this invention compared to the prior art methodology, at least ten fold as much, and in various aspects, 100-fold as much, and 1000-fold as much. In addition, a greater number of the particle population have visualizable polyelectrolyte bound to their surface as 98% of the composite particles prepared using this novel process are modified with polyelectrolyte (as determined by visualization of fluorescence that co-localizes with the particles), compared to only 7% of the particle population prepared by the method described in the prior art. In one aspect, by this measure, the invention provides populations of composite particles that by SYBR green staining are at least 10 percent visualizable (using conventional fluorescence microscopy as described), and more preferably, at least 25 percent visualizable, and still more preferably, at least 90 percent visualizable. The novel composite particles described herein also result in an increase in the efficacy of polyelectrolyte delivery (for example, DNA) using particle acceleration techniques as determined by transfection analysis (FIG. 1). Both the total number of cells transfected in a population and the expression levels in those cells is significantly increased using the composite particles described in this invention. Ballistic delivery of the novel composite particles results in a greater than 4-fold increase in the total number of GFP expressing Neuro2A cells in the population compared to those transfected using particles prepared by the method described in the prior art (i.e. employing the method of Process I). For each transfection the particles were formulated with the same quantity of DNA and total number of particles, respectively, and were delivered by the same ballistic method to each cell population. The novel composite particles described herein result in an increased expression level per cell relative to the particles prepared using the prior art method. In one aspect, composite particles of the invention permit at least 4-fold greater total gene expression levels than particles prepared by Process I.

In another embodiment of this invention the polyelectrolyte to be delivered can be directly immobilized to the carrier particle surface via interaction with oppositely charged polyelectrolyte bound to the carrier particle. For example, a negatively charged carrier particle can be incubated with a positively charged polyelectrolyte, including but not limited to polyethyleneimine, poly-lysine or poly(diallyldimethylammonium chloride) and following washing to remove non-bound polyelectrolyte the carrier particle surface will have a net positive charge at defined pH as determined using zeta potential. This polyelectrolyte coated carrier particle can then be incubated with another negatively charge polyelectrolyte, such as DNA or RNA, which then immobilizes to the particle surface resulting in a composite particle of defined polyelectrolye layers. The zeta potential measurement of these particle preparations is shown in Table 2. Dual or multi layered polyelectrolyte modified particles can be assembled and subsequently delivered to the target. An example of this approach to deliver inhibitory siRNA polyelectrolyte is shown in FIG. 2. When particles modified with sequence specific siRNA for GFP are delivered into cells constitutively expressing GFP there is rapid down-regulation of expression as shown by the loss of fluorescence. After 24 hrs there is greater than 95% inhibition of GFP expression in cells bombarded with polyelectrolyte modified composite particles. In contrast, delivery of control siRNA sequence using the composite particles results in maintenance of GFP expression. In addition, there is no detectable delivery of inhibitory siRNA using standard methods and non-modified particles since there is no detectable immobilization of the polyelectrolyte to the negatively charged carrier particle surface.

When particles are mixed with the dispersed DNA condensates, the DNA condensates bind to the surface of the particles. At the correct particle to DNA ratio, after staining with a fluorescent DNA dye, we find that each particle is strongly fluorescent indicating a high degree of DNA binding. When these particles are used in particle bombardment applications, a large increase in the transfection efficiency of the particles is obtained as detailed in Example 2. In contrast to all previous protocols, known to us, that specify the addition of CaCl₂ and free base spermidine, resulting in an amorphous uncontrolled aggregate, the polyelectrolyte/particle complex (ie. our composite particle) are novel compositions and provide increased performance for particle based bombardment delivery applications.

The method of the prior art will be referred to as Process I:
Process I: particles+free base spermidine, DNA, mixed, and then add CaCl₂. Addition of the spermidine and CaCl₂ can also be reversed in this process.
We will call the preferred procedure for condensate formation Process II: (Note the change in order from Process I, and of course, no CaCl₂.)
Process II: particles+polyelectrolyte, mixed, and then add the condensing agent
Another version of the sequence of addition can be used, which is not quite as desirable as Process II, but also works much better than Process I.
Process III: polyelectrolye+condensing agent mixed to form dispersed polyelectrolyte condensates, then add particles; this results in composite particles with improved properties.
We will call the preferred process for polyelectrolye layering Process IV:
Process IV: polyelectrolyte coated particle+oppositely charged polyelectrolyte(s), mix, spin particles to remove from non-bound polyelectrolyte(s), repeat altering charged polyelectrolyte(s) until the desired number of layers have been assembled.

In one aspect of the invention, particles that consist of disperse polyelectrolyte condensates to be bound to particles are created by polycation-mediated condensation of nucleic acid and their subsequent assembly at the surface of a particle. Condensation refers to the condition in which the nucleic acid structure is of finite size and orderly morphology (Bloomfield 1996). The condensing agent is added to a solution of nucleic acid to form dispersed polyelectrolyte condensates. Particles are mixed with the dispersed polyelectrolyte condensates to form composite particles that can be delivered via a particle gun (or other acceleration method).

### I. Particle Composition

Particles may be formed from any material having sufficient density to be efficiently accelerated into the cells or tissues, or other targets. Non-limiting examples of materials for making particles include copper, gold, tungsten, nickel, aluminum, silver, iron, steels, cobalt, titanium, glass, silica, polymers, and carbon compounds (e.g., graphite, diamond). Metals such as gold are frequently used, as they are inert, nontoxic, and have a high density. The particles should be of a mass sufficiently large to provide the momentum required to penetrate into cells (or other types of targeted material), and also have a surface area that can bind a sufficient quantity of the material to be delivered. The particle should be sufficiently small to avoid excessive damage or disruption of biological function once in contact with the targeted material (e.g. tissue). Particles ranging in diameter from about 0.25 microns to about 4.0 microns have been used in such particle bombardment applications. Particles that are clumped in irregular aggregations are less desirable, as such aggregations will vary widely in their mass and size, thus leading to difficulty in obtaining reproducible results.

In one aspect, a particle has a density between 0.1 and 23 g/cm³ most preferably between 5 and 23 g/cm³. A particle may be solid, porous, or consists of an assemblage of a number of smaller particles. In one aspect, a particle has a diameter of between 100 nm and 100 microns, where a preferred range is between 300 nm and 3 microns. In one aspect, particles may be composed of one or more of the following materials, gold, silver, platinum, nickel, copper, tungsten, alloys, silica, latex, polystyrene, acrylamide, dextran, and ceramics.

In one embodiment of the present invention, the particles are fabricated from metals that include but are not limited to gold, silver, tungsten, platinum, palladium or any alloy thereof. The preferred particle size range is from 50 nm to 5000 nm in diameter and the particle can have a variety of different shapes that include but are not limited to spherical, triangular, elliptical, cylindrical, or platelet. Anisotropic particles have a higher surface area for a given volume and can provide for more efficient delivery of biological material to the cells, tissue or target of interest.

The particles can be homogenous where the same material is used throughout the particle. Alternatively, the particle can be heterogeneous where different areas of the particle have different compositions. One embodiment of a heterogeneous particle is a multi-layer particle where each layer has a different chemical composition. For example, a particle could consist of a solid gold particle that is coated with a layer of silica. Alternatively, the particle could consist of an inorganic core with an arbitrarily thick layer of gold. By varying the size of the starting core and the amount of gold deposited, monodisperse gold nanoshelled particles can be fabricated with extremely narrow size distributions (<5% polydispersity) with a broad range of core sizes (0.1-μm in diameter). Another embodiment of a heterogeneous particle is a particle that consists of many smaller particles that have been dried together to form an aggregate. Another embodiment of a heterogeneous particle is a particle that is porous. Another embodiment is a particle that has an interior that is filled with a liquid. The particles could be composed, in part, of a material that is biodegradable, magnetic, or plays an active role—as a biosensor or as a drug delivery (synthetic drug, anti-sense DNA, RNAi, etc) element.

The surface of the particle may be initially coated with a material chosen to aid in having the polyelectrolyte condensate to preferentially be deposited or become associated with such particle. Additionally, the surface of the particle may be composed of a material that releases the polyelectrolyte condensate in a preferred form or manner from this surface when the composite particle is inside of a cell, tissue or the targeted material.

### II. Particle Surface Charge

In one embodiment of the present invention, the particle initially has a negative charge. In one embodiment the zeta potential of the particle is negative in aqueous solution at a specified pH and the particle is not further functionalized. In another embodiment, the particle is coated with one or more layers that impart a negative charge to the surface of the particle. For example, the coating of a gold particle with a positively charged polymer such as poly(diallyldimethylammonium chloride) followed by a coating of poly(sodium 4-styrene-sulfonate) will result in a particle with a strong negatively charged surface at a specified pH. In another embodiment, a particle with a positively charged surface is mixed with a negatively charged polymer and then added to polyelectrolyte and a condensing agent. In another embodiment, the particle is functionalized with a polymer that facilitates the release of the bound polyelectrolye after intracellular or intra-tissue delivery. In another embodiment, at a specified pH, a positively charged particle is functionalized with negatively charged polyelectrolyte yielding a negatively charged particle. In another embodiment, the particle is coated with a self assembled monolayer to yield either positive, negative or neutral charge at a specified pH.

### III. Order of Addition

As discussed above, in a preferred embodiment, (Process II), the polyelectrolyte and the particle are first mixed in a solution, and then the condensing agent is added.

In another embodiment (Process III), the polyelectrolyte and the condensing agent are first added to a solution, mixed, followed by the addition of the particles. In both Process II and Process III the composite particles formed are very effective ballistic delivery vehicles.

In a further embodiment (Process IV), the polyelectrolyte and particle(s) of opposite charge are first mixed in a solution, and then removed from non-bound polyelectrolyte, to form a composite particle. An additional number of layers can be assembled by repeating the addition of polyelectrolyte of opposite charge to the composite particle. This Process is very effective for delivery of linear, single and double strand polynucleotides including DNA and RNA.

As emphasized, Process I is the teaching of the prior art. Composite particles produced by such a process are referred to herein as “Process I composite particles.”

IV. Ratio of Nucleic Acid (e.g. DNA) to Solid Gold Particles

In one embodiment of this invention a ratio of 0.1 μg-10 μg DNA per 0.95 cm² surface area of particles is preferred. In general, the preferred ratio may depend on the size, surface area, porosity, and density of the particles.

### V. Condensing Agents

Condensing agents coordinate the assembly of dispersed polyelectrolyte condensates assembled in Process II and Process III, and are involved in the subsequent interaction of the polyelectrolyte condensate with the particle to make a composite particle. In one aspect of the present invention, the condensing agents are polycationic molecules selected from the group that consists of spermidine, spermine, basic histones, high mobility group polypeptides, transition protein TP2, non-naturally occurring spermidine and spermine derivatives, cobalt hexamine, poly(ethylenimine), poly-L-lysine, and poly-L-ornithine (Bloomfield, Va., 1996, Curr. Opin. Struc. Biol., 6, 334-341). In a preferred embodiment the condensing reagent concentration is between 0.5-100 mM.

There are a number of chemicals that can disrupt the polyelectrolyte layering and condensation processes. It is an objective of the present invention that these substances be excluded from the composite particle fabrication process. For example, concentrations of mono or divalent cations such as Ca, Na, or Mg in their ion or salt form in combination reduce the amount of polyelectrolyte that can be loaded onto a particle. In one aspect, the concentration of such ions should not exceed a molar ratio of 0.1/1 with the DNA condensing agent or polyelectrolyte.

### VI. Initial Polyelectrolyte Coating

Example of the first positive charged polyelectrolyte coating layer used in Process IV include but is not limited to polyethyleneimine, poly-lysine or poly(diallyldimethylammonium chloride). The negative charged polyelectrolyte layer includes but is not limited to polynucleotides such as DNA or RNA.

### VII. Polyelectrolyte To Be Delivered

Examples of the polyelectrolyte to be delivered using this present invention include polynucleotides such as DNA or RNA or another biologically active molecule that can be condensed using condensing agents.

### VIII. Targets

In any of the referred embodiments, the composite particles prepared in this present invention are suitable for particle gun mediated delivery into cells and tissues from animal, plants, eukaryotes, prokaryotes, fungi, other living organisms, and other non-living materials.

### VIIII. Non-Ballistic Applications

The composite particles formed using the methods described herein have other non-ballistic applications where a layer of polyelectrolyte/high polyelectrolyte binding capacity is useful. One application is the use of the composite particles for delivery of polyelectrolyte to the lungs. Another application is the use of the composite particles for microinjection, or as a nucleic acid transport vehicle in conjunction with other known methods that lead to composite particle internalization by a cell or tissue (electroporation, endocytosis, pinocytosis, magnetofection, Lipofectamine 2000, and the like).

### EXAMPLES

The following examples are intended to provide illustration of the application of the present method. The following examples are not intended to completely define or otherwise limit the scope of the invention.

### Example 1

### Composite Particle Formulation

In this example, the benefit of formulating the particles using a nucleic acid condensing agent is demonstrated by the increased association of fluorescently labeled DNA at the surface of the gold particles. In the improved method described in this invention gold particles (1.6 μm average diameter), typically 2.5 mg from a stock solution of 200 mg/ml in water, are resuspended in 100 μl of 20 mM sodium acetate pH 4.5 in a microfuge tube. The genetic material to be transferred to the cells by bombardment, in this example gWIZ plasmid DNA containing the gene for GFP (green fluorescent protein) (Aldevron, Fargo, S.D.) is added to a concentration of 2.0 μg per mg of particles from a stock resuspended at a concentration of 1 mg/ml in water. The solution is vortexed and the nucleic acid condensing reagent, in this example spermidine-HCl (50 mM in water), is added to yield a final concentration of 25 mM. The solution is incubated at room temperature for 10 minutes, 2 μl SYBR green DNA stain (Molecular Probes, Inc., Eugene, Oreg.) is added, 6 μl of the sample is placed under a coverslip and the sample is visualized with a combination of darkfield and bright field microscopy. A parallel sample is created using the “Standard Method” as described both in the Bio-Rad Helios Gene Gun System instruction manual and extensively in the literature. The gold particles (2.5 mg) are placed in a microfuge tube and suspended in 100 μl of a 50 mM free base spermidine solution (pH 11). A 100 μl aqueous solution containing gWIZ plasmid DNA is added to yield a ratio of 2.0 μg DNA per mg particles and the sample vortexed. While continuing to vortex the sample 100 μl of a 1 M CaCl₂ solution is added dropwise to the sample. The sample is allowed to stand for 10 minutes at room temperature to induce the aggregation and precipitation of DNA. After this incubation period, 2 μl of SYBR green DNA stain is added and 5 μl of this solution is placed under a coverslip. The sample is visualized using a combination of darkfield and bright field microscopy. To determine the amount of DNA associated with the particles for each of the two preparation methods digital images were acquired using a Macrofire CCD. Equivalent exposure times were used for each sample. Image-Pro image analysis software was used to determine the relative amount of fluorescence per field and the number of particles that had detectable associated DNA fluorescence. The data are presented in Table 1.

TABLE 1
Relative DNA Association with Particle Surfaces

| | Total DNA Fluorescence |
|---|---|
| | per 1000 particles |
| Method | (pixel intensity) |
| Standard Method | 62,000 ± 2,400 |
| Method of Invention | 22,564,000 ± 98,000 |

### Example 2

### Particle Bombardment Mediated Transfection

In this example of the invention the benefit is illustrated by an increase in the number of transfected cells obtained when using particles formulated with the invention, “Process II method”, as compared to that using the standard “Prior art” method.

Preparation of Particles with DNA.

The particles prepared as described in Example I were suspended in an ethanol solution. Particle-DNA samples where coated onto Tefzel tubing, dried with nitrogen gas and used for ballistic transformation. These particles can be used to biolistically introduce any plasmid containing a gene of interest and we have used the reporter plasmid containing a coding region for the green fluorescent protein (GFP; commercially available Aldevron, Fargo, N.D.). An optimum plasmid to particle ratio is in the range of 0.1 g to 10 μg plasmid per cm² of particle surface area.

### Cell Preparation.

Neuro2A mouse neuroblastoma cells were used for analysis of biolistic transfection efficiency. Cells were maintained at 37° C. in Dulbecco's Modified Eagles Medium (Invitrogell, Carlsbad, Calif.) supplemented with 10% fetal bovine serum and penicillin/streptomycin. The cells were routinely passaged after they had reached confluence. For biolistic transfection analysis the Neuro2A cells were plated into 35 mm dishes the day prior to biolistic delivery.

### Cell Transfection.

The medium was removed from the cells and the biolistic delivery device (any commercially available PDS-1000 or Helios Gene Gun; Bio-Rad, Hercules, Calif.) was positioned above the cells and particle-DNA complexes were delivered by gas pressure mediated acceleration through a 5 μm pore size polycarbonate membrane. The cells were placed at 37° C. for an additional 4-24 hours and expression levels were determined using fluorescence microscopy. The total number of cells expressing GFP and the intensity output per cell were determined using Image-Pro Image analysis software. The data obtained for each of the two particle sample preparation methods is shown in FIGS. 1A-1C.

### Example 3

Functional siRNA Delivery Using Particle Bombardment

Preparation of polyelectrolyte coated particles. In the method described in this invention gold particles (1.0 μm average diameter), typically 100 mg were suspended in 1 ml of appropriately buffered solution to yield the desired zeta potential for immobilization. A positive charge polyelectrolyte, such as poly-lysine, polyethyleneimine or poly(diallyldimethylammonium chloride) (PDADMAC), was added to a final concentration of between 0.1-1% weight volume and the samples were incubated. The non-bound polyelectrolyte was removed and a second layer is assembled onto the positive charge particles by addition of a negative charge polyelectrolyte, for example siRNA or oligonucleotide. The measured zeta potential of these different particles after each assembly step is shown in Table 2. The optimal ratio of negative charged polyelectrolyte to positive charged particle is between 50-400 pmole per milligram of gold particle. The samples were incubated and non-bound polyelectrolyte was removed from the suspension. Samples with this dual layer can subsequently be processed for ballistic delivery or used for further layers of polyelectrolyte addition.

TABLE 2
Zeta potential of polyelectrolyte modified particles

| Particle | Zeta potential (pH 4.5) |
|---|---|
| Non-modified gold particle | −18.1 ± 4.5 mV |
| Gold particle + PDADMAC | +33.0 ± 4.9 mV |
| Gold particle + PDADMAC + siRNA | −28.4 ± 5.6 mV |

Ballistic Delivery of siRNA Polyelectrolyte.

Particles were prepared as described using a negatively charged polyelectrolyte second layer compromised of a 21 base long synthetic RNA molecule (Qiagen, Valencia, Calif.) of sequence composition complementary to green fluorescent protein (GFP) gene sequence, or alternatively, for use as a negative control, a synthetic RNA whose sequence was non-complementary to GFP. The composite particles were resuspended in an ethanol solution, coated onto Tefzel tubing, dried with nitrogen gas and used for ballistic transformation. The medium was removed from the cells, the biolistic delivery device (a commercially available PDS-1000 or Helios Gene Gun; Bio-Rad, Hercules, Calif.) was positioned above the cells, and particle-polyelectrolyte complexes were delivered by gas pressure mediated acceleration through a 5 μm pore size polycarbonate membrane. The cells were placed at 37° C. and expression levels were monitored at varying times using fluorescence microscopy for an additional 144 hours. Digital images were obtained using a Macrofire CCD, and image intensity per unit area was determined using Image-Pro image analysis software. The data obtained for each of the two particle populations (RNA complementary and non-complementary to the sequence of GFP) are shown in FIGS. 2A-2C.

With respect to the above description then, it is to be realized that the optimum dimensional relationships for the parts of the invention, to include variations in size, materials, shape, form, function, assembly and use, are deemed readily apparent and obvious to one skilled in the art, and all equivalent relationships to those illustrated in the drawings and described in the specification are intended to be encompassed by the present invention. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

### REFERENCES

Antipov, A. A., G. B. Sukhorukov, et al. (2002). “Fabrication of a Novel Type of Metallized Colloids and Hollow Capsules.” Langmuir 18: 6687-6693.
Bloomfield, V. (1996). “DNA condensation.” Current Opinion in Structural Biology 6: 334-341.
Caruso, F., R. A. Caruso, et al. (1998). “Nanoengineering of Inorganic and Hybrid Hollow Spheres by Colloidal Templating.” Science 282: 1111-1114.
Caruso, F., M. Spasova, et al. (2001). “Magnetic Nanocomposite Particles and Hollow Spheres Constructed by a Sequential Layering Approach.” Chem. Mater. 13: 109-116.
Harwood, W., S. Ross, et al. (2000). “The effect of DNA/gold particle preparation technique, and particle bombardment device, on the transformation of barley (Hordeum vulgare).” Euphytica 111(67-76).
O'Brien, J. and S. Lummis (2002). “An improved method of preparing microcarriers for biolistic transfection.” Brain Research Protocols 10: 12-15.
Oldenburg, S. J., R. D. Averitt, et al. (1998). “Nanoengineering of Optical Resonances.” Chem. Phys. Lett. 288: 243-247.
Sanford, J. C. (1987). “Delivery of Substances into Cells and Tissues Using a Particle Bombardment Process.” Particle Science and Technology 5: 27-37.
Sanford, J. C., F. D. Smith, et al. (1993). “Optimizing the Biolistic Process for Different Biological Applications.” Methods in Enzymology 217: 483-509.
Trubetskoy, V., J. Wolff, et al. (2003). “The Role of Microscopic Colloidally Stabilized Phase in Solubilizing Oligoamine-Condensed DNA Complexes.” Biophysical Journal 84: 1124-1130.
Vijayanathan, V., T. Thomas, et al. (2001). “DNA Condensation by Polyamines: A Laser Light Scattering Study of Structural Effects.” Biochemistry 40: 13644-13651.
Yang, W., D. Trau, et al. (2001). “Layer-by-Layer Construction of Novel Bifunctional Fluorescent Microparticles for Immunassay Applications.” Journal of Colloid and Interface Science 234: 356-362.

What is claimed is:

1. A method of preparing composite particles for delivering a polyelectrolyte to a target, the method comprising the steps of:
mixing the polyelectrolyte with a condensing agent to form disperse polyelectrolyte condensates, the condensing agent being a polyelectrolyte having a charge opposite of that of the polyelectrolyte;
combining the disperse polyelectrolyte condensates with particles so that the disperse polyelectrolyte condensates bind to the surfaces of the particles to form composite particles.

2. The method of claim 1 wherein said polyelectrolyte or second polyelectrolyte is a polynucleotide.

3. A method of preparing composite particles for delivering a polyelectrolyte to a target, the method comprising the steps of:
mixing a first polyelectrolyte with a particle of opposite charge to form a polyelectrolyte coated particle,
combining this polyelectrolyte coated particle with a second polyelectrolyte of opposite charge to form composite particles.

4. The method of claim 3 wherein said polyelectrolyte or second polyelectrolyte is a polynucleotide.

5. A method of preparing composite particles for delivering a polyelectrolyte to a target, the method comprising the steps of:
forming a mixture of the polyelectrolyte and a condensing agent in a low salt aqueous solution, the condensing agent being a linear polyelectrolyte having a charge opposite of that of the polyelectrolyte;
adding to the mixture particles each having a surface charge so that polyelectrolyte condensates bind to the surfaces of the particles to form composite particles.

6. A composite particle for delivering polyelectrolyte to a target, the composite particle comprising:
a core particle having a surface with a negative, positive or neutral charge; and
a coating of polyelectrolyte condensates comprising polyelectrolyte and a condensing agent.

7. The composite particle of claim 6 wherein said polyelectrolyte is a polynucleotide and wherein said condensing agent is a polyamine.

8. A composite particle for delivering DNA to a target, the composite particle comprising:
a core particle having a surface with a negative, positive or neutral charge; and
a coating of DNA condensates comprising DNA and a condensing agent.

9. The composite particle for delivering DNA to a target of claim 8, the composite particle comprising:
a core particle having a surface with a negative, positive or neutral charge; and
a coating of DNA condensates comprising DNA and a condensing agent, the DNA condensates being coated on the surface of the particle in an amount that produces at least 25 percent visualized particles upon SYBR Green staining.

10. The composite particle for delivering DNA to a target of claim 8, the composite particle comprising:
a core particle having a surface with a negative charge; and
a coating of DNA condensates comprising DNA and a condensing agent, the DNA condensates being coated on the surface of the particle in an amount that produces transfected Neuro2A cells that express a green fluorescent protein reporter at a level at least two fold greater than that achieved with Process I composite particles.

11. The composite particle for delivering DNA to a target of claim 8, the composite particle comprising:
a core particle having a surface with a negative charge; and
a coating of DNA condensates comprising DNA and a condensing agent, the DNA condensates being coated on the surface of the particle in an amount that produces a number of transfected Neuro2A cells at a level at least two fold greater than that achieved with Process I composite particles.

12. A method of preparing composite particles for injecting DNA into biological cells, the method comprising the steps of:
forming a mixture of the DNA and particles in an aqueous solution, the aqueous solution being substantially free of divalent cations, and
adding to the mixture a condensing agent to the DNA so that DNA condensates form and bind to the surfaces of the particles to create composite particles.

13. A composite particle for delivering a second polyelectrolyte to a target, the composite particle comprising:
a core particle having a first polyelectrolyte surface with a charge; and
a second layer comprising a second polyelectrolyte with an opposite charge.

14. A composite particle of claim 13 wherein said second polyelectrolyte is a polynucleotide.

15. A composite particle for delivering polyelectrolyte to a target, the composite particle comprising:
a core particle having a first polyelectrolyte surface layer with a charge; and
a second layer comprising a second polyelectrolyte with an negative charge in an amount that produces a greater than 50% reduction in expression of a target gene sequence.

16. A multi-layered composite particle for delivering polyelectrolyte to a target, the composite particle having a plurality of coatings of first and second polyelectrolytes and being produced by a process comprising the steps of:
(a) providing a core particle having a charge;
(b) coating the core particle or a coated particle with a first polyelectrolyte having a charge opposite to that of the core particle or the coated particle to form a partially-coated particle having a charge;
(c) coating the partially-coated particle with a second polyelectrolyte having a charge opposite to that of the first polyelectrolyte to form a coated particle; and
(d) repeating steps (b) and (c) until a multi-layered composite particle is formed having a plurality of coatings.

17. A multi-layered composite particle of claim 16 wherein said core particle is from a population of core particles having a size distribution of less than five percent polydispersity.
